(19) United States
(12) Patent Application Publication
(10) Pub. No.: US 2010/0236696 A1
(43) Pub. Date: Sep. 23, 2010

(54) METHOD OF MANUFACTURING GLASSES FRAME MADE OF POLYETHERIMIDE RESIN

(76) Inventor: Joung-Soon KIM, Daegu (KR)

Correspondence Address: CANTOR COLBURN, LLP, 20 Church Street, 22nd Floor, Hartford, CT, 06103, US

(21) Appl. No.: 12/680,808

(22) PCT Filed: Oct. 30, 2007
(86) PCT No.: PCT/KR07/05365

§ 371 Date: Mar. 30, 2010

(51) Int. Cl. B32B 38/10

(52) U.S. Cl. 156/153

(57) ABSTRACT

Disclosed is a method of manufacturing a glasses frame using a polyetherimide resin, through injection molding and cutting, in order to realize excellent properties of the polyetherimide resin. The method of manufacturing a glasses frame made of a polyetherimide resin includes subjecting a polyetherimide resin to injection molding, thus producing a preformed sheet, inputting designs for various glasses models to the preformed sheet, cutting the preformed sheet into the glasses frame according to the input design through laser cutting or CNC cutting, forming lens grooves and hinge grooves in the cut glasses frame, subjecting the rough surface of the glasses frame, having the grooves, to surface treatment through tumbling or polishing, and subjecting the glasses frame, having been subjected to surface treatment, to thermal molding and then to pressing using a mold, thus forming the shape of glasses, and attaching hinges to the formed glasses frame.

### TECHNICAL FIELD

The present invention relates to a method of manufacturing a glasses frame using a polyetherimide resin, and particularly, to a method of manufacturing a glasses frame using a polyetherimide resin, in which a preformed sheet of polyetherimide resin is formed into a glasses body and glasses temples through cutting.

### BACKGROUND ART

Generally, glasses are manufactured by appropriately bending and welding an alloy material, such as a nickel alloy, to thus form a glasses body, producing glasses temples using the same material, and then connecting the glasses body and the glasses temples, between which hinges are disposed, using welding, or alternatively, by subjecting a synthetic resin material to injection molding to thus produce a glasses body and glasses temples, which are then fused to hinges and connected thereby.

Further, methods of manufacturing a glasses frame through injection molding using a synthetic resin material, such as acetate, propionate, or epoxy, have been proposed, but are problematic in that the glasses frame should be manufactured using a mold for injection molding, undesirably requiring many molds corresponding to respective glasses models.

In particular, modern people use glasses frames as a kind of fashion item to show their personal style. Such fashion items are subject to changes in the trend of the times. Before the 1990s, the fashion period for specific glasses frames was about 1˜2years long, but nowadays has considerably shortened, and thus a case where a fashion lasts even 3˜6 months is rare.

Hence, the case of a glasses frame made of synthetic resin is disadvantageous because the period of time required to prepare molds is about 1˜3 months and the period of time required to manufacture the glasses frame is about 2˜3 months, and thus it is very difficult to keep up with trends in glasses fashions and to exceed the break-even point per mold (10,000 per mold).

### DISCLOSURE OF INVENTION

### Technical Problem

Accordingly, the present invention has been made keeping in mind the above problems occurring in the related art, and an object of the present invention is to provide a glasses frame, which is manufactured through injection molding and cutting, in order to realize excellent properties of the polyetherimide resin.

Another object of the present invention is to provide a method of manufacturing a glasses frame using a polyetherimide resin, by which a preformed sheet, which is able to be formed into various glasses model shapes, produced through injection molding, is capable of being directly applied to various glasses models through cutting.

A further object of the present invention is to provide a method of manufacturing a glasses frame using a polyetherimide resin, by which small numbers and various types of glasses frames are capable of being produced without the use of molds for various glasses models, and by which working time can be decreased.

According to the present invention, a glasses body and glasses temples may be formed using a polyetherimide resin, thus facilitating the manufacture of glasses having the same thickness as metal glasses frames and achieving lightweight glasses.

According to the present invention, preformed sheets having the same size may be formed through injection molding, without the need for a plurality of molds, thus reducing the manufacturing cost and the working time.

According to the present invention, desired glasses having various shapes may be obtained by being designed on a computer using CAD or illustration programs and then performing cutting using a laser or a CNC cutting device, without the need for a mold having the shape of the glasses, thus enabling the production of small numbers and various forms thereof, consequently enabling rapid response to fashion trends, which change quickly.

According to the present invention, a glasses frame (including a glasses body and glasses temples) may be formed through flat cutting using a preformed sheet, thus remarkably decreasing the generation of loss, consequently reducing material purchase expenses.

According to the present invention, desired patterns or colors may be directly imprinted using sublimation transfer paper, thus obviating the need to perform additional coloring.

According to the present invention, a glasses frame may be manufactured from a polyetherimide resin through flat processing, thus realizing high hardness, light weight, easy cutting and a good fit, consequently being safe and stable for a person wearing glasses.

### BRIEF DESCRIPTION OF THE DRAWINGS

FIG. 1 is a flowchart illustrating the manufacturing process according to the present invention;

FIG. 2 is a view illustrating the preformed sheet obtained through injection molding, according to the present invention; and

FIG. 3 is a view illustrating the glasses completed through cutting, according to the present invention;

### DESCRIPTION OF THE REFERENCE NUMERALS IN THE DRAWINGS

10, 11: preformed sheet

12: glasses-shaped polyetherimide resin

13: lens groove

14: hinge groove

### MODE FOR THE INVENTION

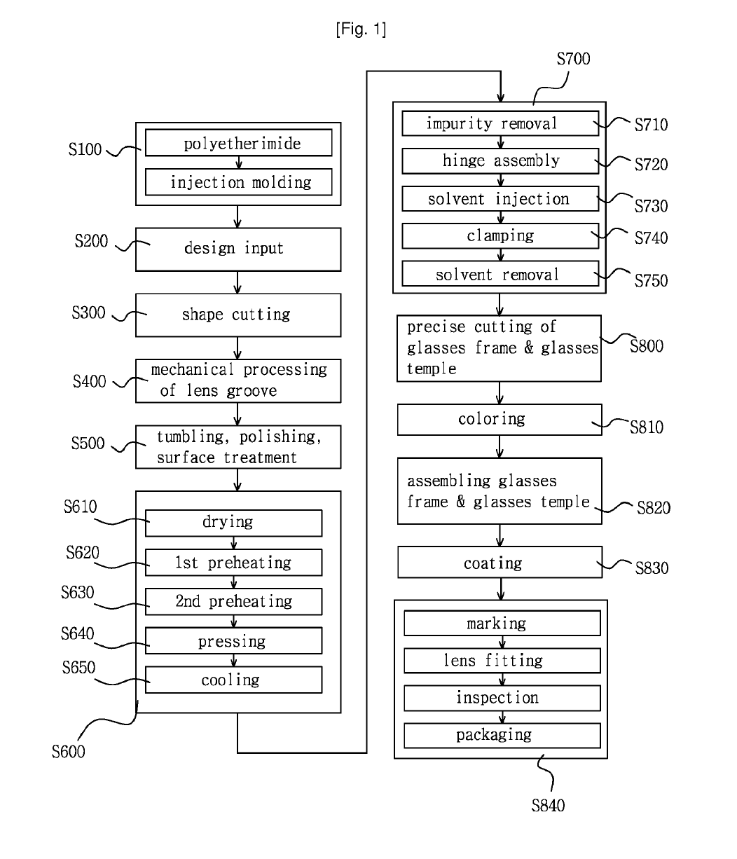

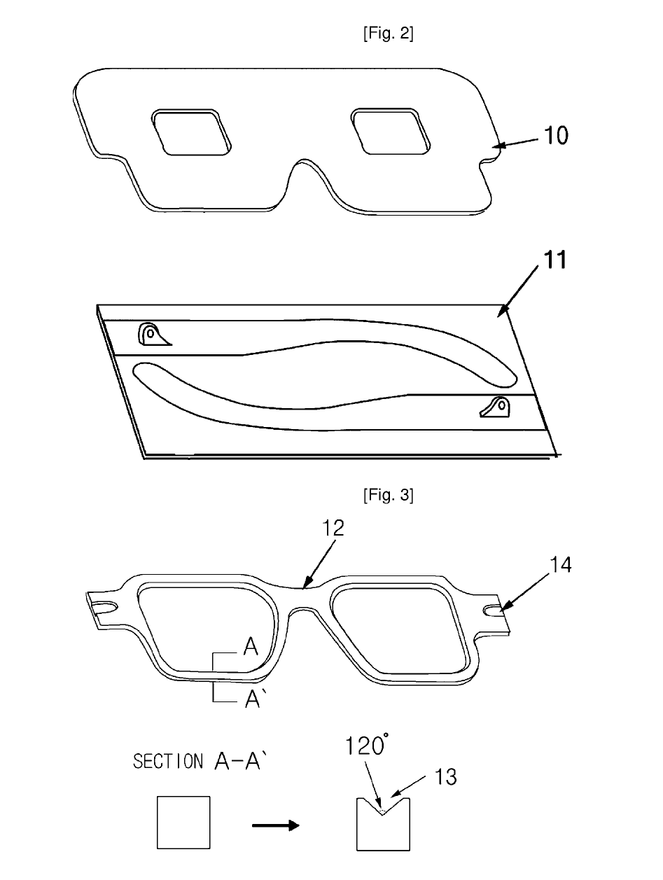

FIG. 1 is a flowchart illustrating the manufacturing process according to the present invention, FIG. 2 is a view illustrating the preformed sheet obtained through injection molding, according to the present invention, and FIG. 3 is a view illustrating the glasses completed through cutting, according to the present invention. According to the present invention, a method of manufacturing a glasses frame includes subjecting a polyetherimide resin to injection molding to produce a preformed sheet, inputting design for various glasses models to the preformed sheet, cutting the performed sheet into a glasses frame according to the input model design through laser cutting or CNC cutting, forming various grooves through mechanical processing, performing surface treatment and thermal molding to thus form the shape of the glasses frame, and then attaching hinges to the glasses frame.

Specifically, the method of the present invention includes subjecting the polyetherimide resin to injection molding to thus produce the preformed sheet (S100), inputting the design for various glasses models to the preformed sheet (S200), cutting the preformed sheet into the shape of the glasses frame according to the input design through laser cutting or CNC cutting (S300), processing lens grooves and hinge grooves in the cut glasses frame (S400), subjecting the rough surface of the glasses frame having the grooves to surface treatment through tumbling or polishing (S500), subjecting the glasses frame, subjected to surface treatment, to thermal molding and then pressing using a mold to thus form the shape of glasses (S600), and then attaching the hinges to the glasses frame thus formed (S700).

In the injection molding for the preformed sheet (S100), the polyetherimide resin is subjected to injection molding so as to be formed into sizes and shapes that can be used to manufacture a glasses body or glasses temples, and, as shown in FIG. 2, may be appropriately sized through injection molding using a mold, in order to manufacture glasses.

The polyetherimide is very hard and is strongly resistant to shocks and thermal deformation to the extent that no deformation occurs even at high temperatures (246° C.), and also has high fusibility.

In the present invention, preformed sheets 10, 11 are produced from the polyetherimide resin, which has superior properties as above, through injection molding, and the preformed sheet thus obtained is a flat sheet having a size able to accommodate the design for various glasses models, for example, a thickness of 1.4˜2.5 mm. Specifically, the preformed sheet 10 for a glasses body has a thickness of about 1.8˜2.5 mm, and the preformed sheet 11 for glasses temples has a thickness of about 1.4˜2.0 mm.

The preformed sheet for a glasses body has a size of 165 mm×60 mm×2 mm (width×length×thickness), and the preformed sheet for glasses temples has a size of 165 mm×60 mm×1.4 mm (width×length×thickness), but the width, the length and the thickness are not limited to the above numeric values and may vary depending on the size and end use of the glasses.

Although polyetherimide resin may be subjected to extrusion and rolling to thus form a flat sheet having a large size and a controllable thickness, the case where the flat sheet having a large size is produced increases the generation of wasted portions upon the manufacture of the glasses frame (a glasses body and glasses temples), resulting in increased manufacturing costs. However, according to the present invention, the injection molding for the preformed sheet remarkably decreases the generation of wasted portions upon the manufacture of the glasses frame, thus alleviating economic burden.

In the inputting of the design (S200), the design for desired glasses models is set on a computer and is input to the preformed sheet, and preferably, the design for glasses models is input by means of various graphics programs using the computer. The design input method using the computer and the programs is a known technique, and thus a detailed description thereof is omitted. In the inputting of the design, the design for various glasses models may be set and input.

In the cutting (S300), the preformed sheet is cut into the shape of the glasses frame with the operation of a cutting device according to the design input by the computer, and preferably, laser cutting or CNC cutting may be conducted.

In order to aid the understanding of the present invention, for laser cutting, polyetherimide plastic may be processed using an intermediate range CO2 laser (50˜500 watts). The CO2 laser is used at 10.6 microns, corresponding to a wavelength that is completely absorbed by the plastic material. When such a beam is concentrated on one point, power density is considerably increased. Thus, when a beam of 275 watts is concentrated on a point having a diameter of 0.005 inches (0.13 mm), power density is increased. When a sample (a preformed sheet) is irradiated with such a beam, the local temperature of a portion thereof is instantaneously increased, such that the energized material is instantly converted into a vapor, thereby easily removing the material. Hence, the material is processed without debris or remnants.

The laser processing of the polyetherimide does not require that high mechanical external pressure be applied to the material, and thus incurs no distortion and no increase in stress, and furthermore, the efficiency thereof is higher than conventional processing techniques. Also, because a laser may be optically divided into several beams, simultaneous working is possible, leading to increased productivity. When general plastic is cut using a laser, powdery remnants are generated on the cut surface. However, in the present invention, because the preformed sheet, which is obtained from the polyetherimide resin through injection molding, is processed, remnants may be easily removed from the polyetherimide upon laser processing, resulting in a clear cut surface.

The CNC cutting is conducted through mechanical processing. When the preformed sheet is subjected to cutting, milling, drilling, tapping, turning, and grinding, in that order, a desired glasses model may be obtained therefrom. The above work is a known technique that is widely used in CNC cutting, and thus a detailed description thereof is omitted.

From the glasses frame thus obtained, residual stress should be removed through annealing.

In the annealing, an open mesh type air-circulation oven is used, and the temperature of the oven is increased to 190˜210° C. at a rate of 20˜° C. per hour. After this temperature is maintained for a minimum of 4 hours, the oven is cooled to room temperature at a rate of 20˜30° C. per hour. Preferably, the temperature of the oven is increased to at least 196° C. at a rate of 24° C. per hour, maintained at 196° C. for a minimum of 4 hours, and then decreased to room temperature at a rate of 24° C. per hour.

Such annealing is responsible for eliminating the stress generated in the course of mechanical processing, thereby forming reliable glasses having a long lifetime.

In the formation of the grooves (S400), lens grooves 13 and hinge grooves 14 are processed in the glasses-shaped polyetherimide resin 12, and the grooves are formed in the cut glasses frame (a glasses body and glasses temples) through mechanical processing. These grooves may be formed using a machine for forming only glasses grooves, said machine for forming only glasses grooves being known in the art, and thus a detailed description thereof is omitted.

In the surface treatment (S500), the rough state of the corners and surface of the glasses frame, generated upon the cutting or formation of the grooves, is processed to be smooth through tumbling or polishing.

In the formation of the shape of the glasses (S600), the shape of the glasses, obtained from the preformed sheet, which is flat, is formed into an actual glasses shape. This procedure includes drying the polyetherimide resin, cut into the shape of the glasses frame (S610), primarily preheating the dried polyetherimide resin (S620), secondarily preheating the primarily preheated polyetherimide resin to transform it (S630), pressing the secondarily preheated polyetherimide resin using a preheated mold mounted in a hydraulic press (S640), and separating the pressed glasses frame from the hydraulic press and then cooling it with water (S650).

After primarily preheating the dried polyetherimide resin, sublimation transfer paper may be subsequently attached. That is, upon hydraulic pressing, the polyetherimide resin is pressed along with the sublimation transfer paper using a computer graphics system, and thereby a desired pattern or color may be imprinted in the glasses frame. Because the sublimation transfer requires heat of 150° C. or higher, it cannot be applied to other materials for glasses, but can be realized only in the present invention using polyetherimide, ultimately reducing the cost and easily patterning or coloring the glasses.

The drying (S610) is conducted at 140˜155° C., preferably 150° C., for about 2˜3.5 hours, preferably 2.5 hours in the case of a flat sheet having a thickness of 1.5˜2.0 mm, in order to prevent the generation of foam upon the pressing.

In the primary preheating (S620), the polyetherimide resin, cut into the shape of the glasses, is preheated to about 150˜170° C. by means of a conveyor system using an electric heater or a halogen lamp heater.

In the secondary preheating (S630), the polyetherimide resin, cut into the shape of the glasses, is heated and is thus formed into the actual glasses shape. Because the polyetherimide resin is thermally transformed at high temperatures of 246˜274° C., heat of 246˜274° C. is required in order to form the shape of the glasses. Thus, a shaping mold is preheated to about 250˜270° C. using an electric heater connected thereto. As such, the mold has upper and lower divisions as in general molds for presses, and is mounted in a hydraulic press for tables.

In the pressing (S640), the secondarily preheated glasses frame is placed in the preheated mold, which is mounted in the hydraulic press, and is then pressed for about 1˜10 sec using the press.

In the cooling (S650), the pressed glasses frame is separated from the press, and is then cooled with water.

In the attachment of the hinges (S700), the glasses body and the glasses temples are connected. This procedure includes removing impurities such as grease, oil or dust from the surface of the glasses frame using isopropylalcohol or heptane (S710), assembling the hinges with the glasses body and the glasses temples and maintaining an assembly state without change (S720), injecting sufficient solvent between the glasses frame and the hinges using an injector to wet the entire surface of the glasses frame (S730), clamping the glasses frame and the hinges at a pressure of about 100 psi while holding the glasses frame and the hinges (S740), and maintaining a clamped state and then placing the glasses frame and the hinges, which are adhered to each other, in an oven at 30˜50° C., thus completely evaporating the solvent therefrom (S750).

In the clamping (S740), the clamping time varies depending on the types of hinge, and the clamped state is preferably maintained for about 1˜5 min.

The solvent may be selected from among methylene chloride, chloroform, chlorobenzene, dichlorobenzene, cresol, NMP (N-methylpyrrolidinone), DMF (dimethyl formamide), DMSO (dimethyl sulfoxide), DMAC (dimethyl acetamide), anisole, O-dimethoxy benzene, pyridine, nitrobenzene, methyl benzoate, benzonitrile, and acetophenone.

In addition to the above process steps, precisely cutting the glasses frame to an accurate shape (S800), coloring the precisely cut glasses frame (S810), assembling the produced glasses body and glasses temples (S820), coating the assembled glasses body and glasses temples with urethane (S830), and conducting finishing treatment (S840) may be further conducted. These process steps are the same as in conventional methods of manufacturing glasses frames from synthetic resin through injection molding, and thus a detailed description thereof is omitted.

The polyetherimide resin used in the present invention has been described to be made into the preformed sheet using the dedicated injection molding and cutting, or the polyetherimide resin may also be made into the preformed sheet using known injection molding used for synthetic resin, so that the resulting thickness may be equal to or similar to that of the metal glasses frame, and furthermore, glasses frames having a light weight and high hardness may be formed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A method of manufacturing a glasses frame made of a polyetherimide resin, comprising:
subjecting a polyetherimide resin to injection molding, thus producing a preformed sheet;
inputting a design for various glasses models to the preformed sheet;
cutting the preformed sheet into a glasses frame according to the input design through laser cutting or CNC cutting;
forming lens grooves and hinge grooves in the cut glasses frame;
subjecting a rough surface of the glasses frame having the grooves to surface treatment through tumbling or polishing;
subjecting the glasses frame, having been subjected to surface treatment, to thermal molding and then pressing using a mold, thus forming a shape of glasses; and
attaching hinges to the formed glasses frame.

2. The method according to claim 1, wherein the preformed sheet has a thickness of 1.4˜2.5 mm.

3. The method according to claim 1, wherein the cutting is conducted through laser cutting or CNC cutting.

4. The method according to claim 1, wherein the forming the shape of the glasses comprises:
drying the polyetherimide resin, cut to a shape of the glasses frame;
primarily preheating the dried polyetherimide resin to 150˜170° C.;
secondarily preheating the primarily preheated polyetherimide resin to 250˜270° C. to transform it;
pressing the secondarily preheated polyetherimide resin using a preheated mold mounted in a hydraulic press; and
separating the pressed glasses frame from the hydraulic press and then cooling it with water.

5. The method according to claim 4, wherein the drying is conducted at 140˜155° C. for 2˜3.5 hours.

6. The method according to claim 4, wherein the forming the shape of the glasses further comprises attaching a sublimation transfer paper having a predetermined pattern or color, after primarily preheating the polyetherimide resin.

7. The method according to claim 1, wherein the attaching the hinges comprises:
removing impurities, including grease, oil or dust, from a surface of the glasses frame using isopropyl alcohol or heptane;
assembling the hinges with the glasses frame, including a glasses body and glasses temples, and maintaining an assembly state without change;
injecting sufficient solvent between the glasses frame and the hinges using an injector to wet an entire surface of the glasses frame;
clamping the glasses frame and the hinges at a pressure of 100 psi while holding the glasses frame and the hinges; and
maintaining a clamped state, and then placing the glasses frame and the hinges, which are adhered to each other, in an oven at 30˜50° C., thus completely evaporating the solvent.

8. The method according to claim 7, wherein the solvent is one selected from among methylene chloride, chloroform, chlorobenzene, dichlorobenzene, cresol, NMP (N-methylpyrrolidinone), DMF (dimethyl formamide), DMSO (dimethyl sulfoxide), DMAC (dimethyl acetamide), anisole, O-dimethoxy benzene, pyridine, nitrobenzene, methyl benzoate, benzonitrile, and acetophenone.
